(19) United States
(12) Patent Application Publication
(10) Pub. No.: US 2017/0136968 A1
(43) Pub. Date: May 18, 2017

(54) IN-VEHICLE ELECTRICITY STORAGE SYSTEM

(71) Applicant: Panasonic Intellectual Property Management Co., Ltd., Osaka (JP)

(72) Inventors: MAMORU MUKUNO, Osaka (JP); KEIJI KISHIMOTO, Hyogo (JP)

(21) Appl. No.: 15/325,894

(22) PCT Filed: Jul. 24, 2015
(86) PCT No.: PCT/JP2015/003721

§ 371 Date: Jan. 12, 2017

(30) Foreign Application Priority Data
Aug. 5, 2014 (JP) 2014-159182

(51) Int. Cl. B60R 16/033; H01M 10/42; H02J 7/16; H01M 10/48; H01M 10/44; H02J 7/00; H01M 10/20; H01M 10/46

(52) U.S. Cl. CPC B60R 16/033; H01M 10/20; H01M 10/4207; H01M 10/46; H01M 10/48; H01M 10/425; H01M 10/441; H02J 7/0068; H02J 7/16; H01M 2220/20; H01M 2010/4271

(57) ABSTRACT

When a charge state of an auxiliary battery transitions to a first charge state, a charge/discharge controller executes a first process in which a first voltage is applied to an in-vehicle power supply unit to charge the in-vehicle power supply unit with a constant voltage. When the charge state of the auxiliary battery transitions to a second charge state, the charge/discharge controller executes a second process in which a second voltage is applied to the in-vehicle power supply unit, charging of the auxiliary battery is stopped, and the auxiliary battery is caused to discharge electricity to an electrical component load or the like. The charge/discharge controller repeats the first process and the second process until a charge state of a lead storage battery transitions to a third charge state.

### TECHNICAL FIELD

The present invention relates to an in-vehicle electricity storage system that supplies electric power to a starter motor of a vehicle, and to electrical component loads.

### BACKGROUND ART

A lead storage battery is widely used in an in-vehicle electricity storage system that supplies electric power to a starter motor of a vehicle, and to electrical component loads. Compared with a nickel-hydride battery having different electrical properties including energy density, a lead storage battery is inexpensive, but easily degrades when deep charging and discharging cycles are repeated. Thus, a lead storage battery in which a State Of Charge (SOC, also referred to as a charging rate) is kept higher has been desired. An idle stop function and an energy regeneration function have widely been provided to vehicles manufactured in recent years for improving fuel efficiency. However, deep charging and discharging cycles are required to achieve such functions, which is sometimes difficult for a single lead storage battery to keep a higher SOC. To solve this problem, a conventional method configures an in-vehicle electricity storage system in which a nickel-hydride battery having higher energy density is connected in parallel to a lead storage battery via a switch (see PTL 1 listed below).

### CITATION LIST

### Patent Literature

PTL 1: Unexamined Japanese Patent Publication No. 2004-328988

### SUMMARY OF THE INVENTION

Incidentally, when charging, with a constant voltage, a lead storage battery and a nickel-hydride battery connected in parallel to each other, the nickel-hydride battery can often reach a full charge state faster than the lead storage battery because charge-acceptability of the nickel-hydride battery is superior to charge-acceptability of the lead storage battery. To keep charging the lead storage battery after the nickel-hydride battery reaches the full charge state, a charging voltage needs to be adjusted to prevent the nickel-hydride battery connected in parallel from becoming an overcharge state. This means that, after the nickel-hydride battery reaches the full charge state, the lead storage battery may not be charged with a desired constant voltage, thus charging efficiency for the lead storage battery may be lowered.

Therefore, an object of the present invention is to provide an in-vehicle electricity storage system capable of, after a secondary, auxiliary battery such as nickel-hydride battery connected in parallel reaches a full charge state, charging a lead storage battery with a constant voltage while preventing lowering of charging efficiency.

An in-vehicle electricity storage system according to the present invention includes an in-vehicle power supply unit including a lead storage battery, and an auxiliary battery connected in parallel to the lead storage battery, a detector that detects a charge state of the lead storage battery and a charge state of the auxiliary battery, and a charge/discharge controller that executes, when the charge state of the auxiliary battery transitions to a first charge state where charging of the auxiliary battery is to be started, a first process in which a first voltage is applied to the in-vehicle power supply unit to start charging the in-vehicle power supply unit with a constant voltage so as to cause the charge state of the auxiliary battery to transition to a second charge state where the charging of the auxiliary battery is to be stopped, executes, when the charge state of the auxiliary battery transitions to the second charge state, a second process in which the charging with the constant voltage is stopped, and a second voltage that is lower than the first voltage is applied to the in-vehicle power supply unit so as to cause the auxiliary battery to transition to the first charge state, and alternately repeats the first process and the second process until the charge state of the lead storage battery transitions to a third charge state where charging of the lead storage battery is to be stopped.

According to the present invention, an in-vehicle electricity storage system can be provided which is capable of, after an auxiliary battery such as nickel-hydride battery connected in parallel reaches a full charge state, charging a lead storage battery with a constant voltage while preventing lowering of charging efficiency.

### BRIEF DESCRIPTION OF DRAWINGS

FIG. 1 is a view illustrating a vehicle mounted with a vehicular electricity storage system according to an exemplary embodiment of the present invention.

FIG. 2 is a graph illustrating time transitions in respective charging rates of a lead storage battery and an auxiliary battery of an in-vehicle power supply unit according to the exemplary embodiment of the present invention.

FIG. 3 is an operation flowchart with regard to a constant voltage charge control performed by the in-vehicle power supply unit.

### DESCRIPTION OF EMBODIMENT

An overview of an exemplary embodiment of the present invention will now be described prior to specifically describing the exemplary embodiment of the present invention. A terminal voltage of a storage battery in a no load state is referred to as an Open-Circuit Voltage (OCV). On the other hand, a terminal voltage of the storage battery while charging or discharging is referred to as a Closed-Circuit Voltage (CCV). When a current flowing into the storage battery is denoted as Id, while an internal resistance is denoted as Rd, the OCV and the CCV have a relationship represented by the following equation (1).

CCV=OCV±Id×Rd (1)

Here, + indicates charging, while − indicates discharging. In addition, Id×Rd is referred to as a polarization voltage. The polarization voltage lowers the OCV when discharging, and raises the OCV when charging.

When a lead storage battery having a rated voltage of 12 V is charged with a constant voltage, such a voltage that causes a CCV of the lead storage battery to fall within a range from 13.5 V to 14.5 V is normally applied. As is apparent from the equation (1), as a difference between a CCV and an OCV is greater or an internal resistance is smaller, a charging current is increased. That is, as the applied voltage is higher, the time required for charging with the constant voltage becomes shorter.

However, when charging with a higher, constant voltage of 14.5 V, for example, continues after a nickel-hydride battery connected in parallel to a lead storage battery reaches a full charge state, the nickel-hydride battery may reach an overcharge state. On the other hand, when the lead storage battery is charged with such a constant voltage that does not cause the nickel-hydride battery to reach an overcharge state, a time required for the charging with the constant voltage becomes longer. For a lead storage battery, an OCV and an internal resistance become higher when charging, because the lead storage battery has to be charged and discharged so that an SOC falls within a range in which the SOC is kept higher (for example, 80% or higher) to prevent the lead storage battery from being degraded. This means that, when a CCV is lowered while a lead storage battery is charged with a constant voltage, a charging current is reduced, thus a time required for charging with the constant voltage becomes longer. In other words, as a time required for charging a lead storage battery with a constant voltage becomes longer, charging efficiency is lowered. Thus, it is desired that, even after a nickel-hydride battery connected in parallel to the lead storage battery reaches a full charge state, the lead storage battery is kept charged with a higher, constant voltage.

To solve this problem, a vehicular electricity storage system according to the exemplary embodiment of the present invention alternately repeats, for example, a first process in which a higher voltage of 14.5 V is applied for charging with a constant voltage to cause a nickel-hydride battery that is in a state where charging is required to transition to a full charge state, and a second process in which a voltage applied to the lead storage battery is switched to a second voltage that is lower than the first voltage and higher than an OCV of the lead storage battery to cause the nickel-hydride battery in the full charge state to transition to a state where charging is required. By alternately repeating these processes, charging of the lead storage battery with a higher, constant voltage can be achieved without causing the nickel-hydride battery connected in parallel to the lead storage battery to reach an overcharge state, thereby preventing lowering of charging efficiency for the lead storage battery.

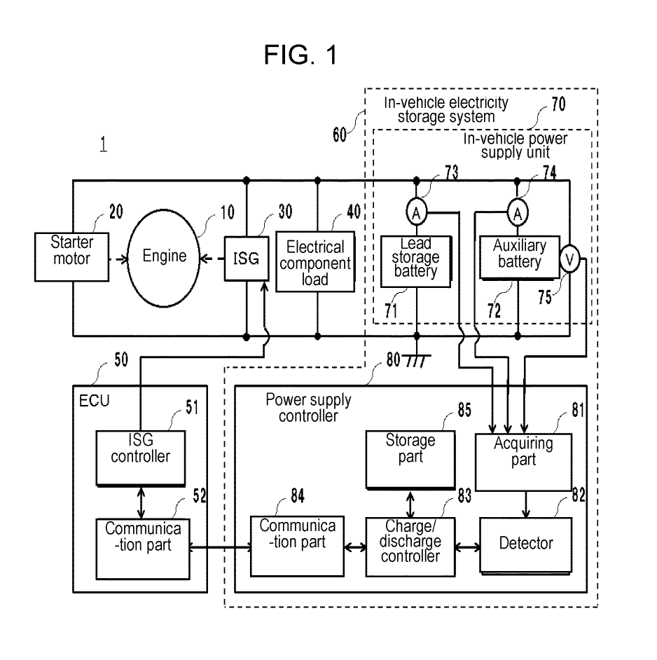

FIG. 1 is a view illustrating vehicle 1 mounted with in-vehicle electricity storage system 60 according to this exemplary embodiment. It is assumed that vehicle 1 is a Hybrid Electric Vehicle (HEV) including an engine as a main power source and a motor as an auxiliary power source. Vehicle 1 includes engine 10, starter motor 20, Integrated Starter Generator (ISG) 30, electrical component load 40, Electronic Control Unit (ECU) 50, and in-vehicle electricity storage system 60. In-vehicle electricity storage system 60 includes starter motor 20, ISG 30, in-vehicle power supply unit 70 for supplying electric power to electrical component load 40, and power supply controller 80 for measuring a voltage value and the like of lead storage battery 71, and for controlling charging and discharging of in-vehicle power supply unit 70. Starter motor 20, ISG 30, and electrical component load 40 are connected in parallel to in-vehicle power supply unit 70.

When a user operates an ignition switch, starter motor 20 starts engine 10. ISG 30 has both a generator function and an electric power operation function. When a brake pedal (not illustrated) is operated while vehicle 1 is running, and vehicle 1 starts slowing down, wheels transmit torque to ISG 30, and ISG 30 generates electric power through the generator function. When the electric power generated by ISG 30 exceeds electric power consumed by electrical component load 40, excessive electric power is charged in in-vehicle power supply unit 70. Therefore, energy is regenerated. If the electric power operation function is not required, ISG 30 can be replaced with an alternator having only a generator function.

As vehicle 1 stops, an idle stop control of ECU 50 causes engine 10 to automatically stop. When vehicle 1 starts to move, the electric power operation function of ISG 30 drives vehicle 1, and meanwhile, starts engine 10. In addition, when an accelerator pedal (not illustrated) is operated while vehicle 1 is running, an assist control of ECU 50 distributes torque between engine 10 and ISG 30. ISG 30 generates torque to be distributed through the electric power operation function to drive vehicle 1 together with engine 10.

Electrical component load 40 includes a load, for example, electrical components, such as an air conditioner and interior lights, equipped in vehicle 1. Electric power supplied from in-vehicle power supply unit 70 is used for a power supply of electrical component load 40.

ECU 50 includes, for example, a Central Processing Unit (CPU) that executes predetermined arithmetic processing, a Read Only Memory (ROM) stored with a predetermined control program, a Random Access Memory (RAM) for temporarily storing data, peripheral circuits, and the like. ECU 50 is configured to be communicable with power supply controller 80. ECU 50 controls all operations of vehicle 1, including, engine 10, starter motor 20, ISG 30, and electrical component load 40. For example, ECU 50 performs the idle stop control in which, when vehicle 1 satisfies a predetermined stop condition, such as when vehicle 1 stops for a predetermined period at an intersection or the like, engine 10 automatically stops, and, when vehicle 1 satisfies a predetermined start condition, such as when the brake pedal (not illustrated) is released, engine 10 starts again. When performing the idle stop control or the like, ECU 50 receives, from power supply controller 80, battery state information that contains a voltage value and the like of lead storage battery 71, and appropriately refers to the battery state information. For example, when ECU 50 determines that, based on the battery state information, in-vehicle power supply unit 70 has small remaining capacity so that sufficient electric power cannot be supplied to ISG 30 when restarting engine 10 from an idle stop state, ECU 50 prohibits engine 10 from transitioning to the idle stop state.

Based on an instruction given by power supply controller 80, ISG controller 51 controls the generator function of ISG 30. ISG controller 51 controls an excitation current of a rotor coil (not illustrated) of ISG 30 to control a voltage output from ISG 30. When power supply controller 80 instructs ISG controller 51 to raise a voltage to be output from ISG 30, ISG controller 51 increases an excitation current of the rotor coil. On the other hand, when power supply controller 80 instructs ISG controller 51 to lower the voltage to be output from ISG 30, ISG controller 51 decreases the excitation current of the rotor coil. Communication part 52 processes signals to be communicated with power supply controller 80 via a network such as Controller Area Network (CAN) (for example, for forming a frame, and for converting a transmission system into a differential transmission system). Communication part 52 outputs battery state information received from power supply controller 80 to ISG controller 51.

In-vehicle power supply unit 70 includes lead storage battery 71 having a rated voltage of 12 V, and auxiliary battery 72 that has electrical properties, such as energy density, which differ from electrical properties of lead storage battery 71, and that is connected in parallel to lead storage battery 71. It is assumed that in-vehicle power supply unit 70 according to this exemplary embodiment uses, as an auxiliary battery 72, a nickel-hydride battery having higher energy density than energy density of lead storage battery 71. A rated voltage of the nickel-hydride battery is 1.2 V/cell. Therefore, auxiliary battery 72 includes 10 nickel-hydride batteries connected in series with each other. Note that auxiliary battery 72 can be achieved with, for example, a secondary battery such as lithium-ion battery, a capacitor, or the like.

In-vehicle power supply unit 70 includes current sensor 73 connected in series with lead storage battery 71 to detect a value of a current flowing into lead storage battery 71, and current sensor 74 connected in series with auxiliary battery 72 to detect a value of a current flowing into auxiliary battery 72. Current sensors 73, 74 are configured by shunt resistors, for example. In addition, in-vehicle power supply unit 70 includes voltage sensor 75 connected in parallel to lead storage battery 71 and auxiliary battery 72 to detect values of terminal voltages of lead storage battery 71 and auxiliary battery 72 connected in parallel to each other.

Power supply controller 80 includes, for example, a CPU that executes predetermined arithmetic processing, a ROM stored with a predetermined control program, a RAM for temporarily storing data, peripheral circuits, and the like. Power supply controller 80 includes acquiring part 81, detector 82, charge/discharge controller 83, communication part 84, and storage part 85.

Acquiring part 81 AD-converts a current value received from current sensor 73, obtains a digitalized current value (Ip, also referred to as a first current value), and outputs the value to detector 82. Similarly, acquiring part 81 obtains a digitalized current value (In, also referred to as a second current value) from a current value received from current sensor 74, and outputs the value to detector 82. In addition, acquiring part 81 AD-converts a terminal voltage value received from voltage sensor 75, obtains a digitalized voltage value (Vo, also referred to as a whole voltage value), and outputs the value to detector 82.

Detector 82, for example, integrates first current value Ip received from acquiring part 81, and detects charging rate (SOCp) of lead storage battery 71. Similarly, detector 82 integrates second current value In received from acquiring part 81, and detects charging rate (SOCn) of auxiliary battery 72.

In addition, for example, referring to an I-V table indicating a correspondence relation between a terminal voltage of lead storage battery 71 and a current flowing into lead storage battery 71, based on whole voltage value Vo and first current value Ip received from acquiring part 81, detector 82 detects internal resistance (Rp) in lead storage battery 71. Similarly, detector 82 detects, based on whole voltage value Vo and second current value In received from acquiring part 81, internal resistance (Rn) in auxiliary battery 72. In addition, detector 82, for example, substitutes whole voltage value Vo and first current value Ip received from acquiring part 81, and detected internal resistance Rp into the equation (1) to detect open-circuit voltage (OCVp) of lead storage battery 71, which corresponds to charging rate SOCp of lead storage battery 71. Detector 82 configures battery state information based on first current value Ip and the like received from acquiring part 81, and calculated charging rate SOCp and the like, and outputs the battery state information to charge/discharge controller 83.

Charge/discharge controller 83 sends, based on the battery state information received from detector 82, an instruction to ECU 50 via communication part 84 to adjust a voltage output from ISG 30 to control charging and discharging of in-vehicle power supply unit 70. When each of charging rate SOCp of lead storage battery 71 and charging rate SOCn of auxiliary battery 72 is lower than a respective lower limit of a control-target range due to discharging of electricity to electrical component load 40 or the like, charge/discharge controller 83 instructs ECU 50 to raise a voltage to be output from ISG 30 to limit discharging of electricity from in-vehicle power supply unit 70.

On the other hand, when charging rate SOCp of lead storage battery 71 and charging rate SOCn of auxiliary battery 72 exceed a respective upper limit of the control-target range due to charging from ISG 30, charge/discharge controller 83 instructs ECU 50 to lower the voltage to be output from ISG 30 to limit charging of in-vehicle power supply unit 70.

For convenience of description, it is assumed that the control-target range for the charging rate of lead storage battery 71 (also referred to as a first control-target range) is from 80% to 95%, while the control-target range for the charging rate of auxiliary battery 72 (also referred to as a second control-target range) is from 20% to 100%, but the present invention is not limited to these ranges.

Charge/discharge controller 83 refers to a threshold value with regard to the charging rate of auxiliary battery 72 to determine a charge state of auxiliary battery 72. Specifically, when charging rate SOCn of auxiliary battery 72 is lower than a first threshold value, charge/discharge controller 83 determines that auxiliary battery 72 is in a charge state where charging is to be started (also referred to as a first charge state). When charging rate SOCn of auxiliary battery 72 is greater than a second threshold value, charge/discharge controller 83 determines that auxiliary battery 72 is in a charge state where charging is to be stopped (also referred to as a second charge state). Here, the lower limit value (20%) of the second control-target range can be adopted as the first threshold value, while the upper limit value (100%) of the second control-target range can be adopted as the second threshold value. Similarly, when charging rate SOCp of lead storage battery 71 is greater than a third threshold value, charge/discharge controller 83 determines that lead storage battery 71 is in a charge state where charging is to be stopped (also referred to as a third charge state). When charging rate SOCp of lead storage battery 71 is lower than the first threshold value, charge/discharge controller 83 determines that lead storage battery 71 is in a charge state where charging is to be started (also referred to as a fourth charge state). The upper limit value (95%) of the first control-target range can be adopted as the third threshold value, while the lower limit value (80%) of the first control-target range can be adopted as the fourth threshold value.

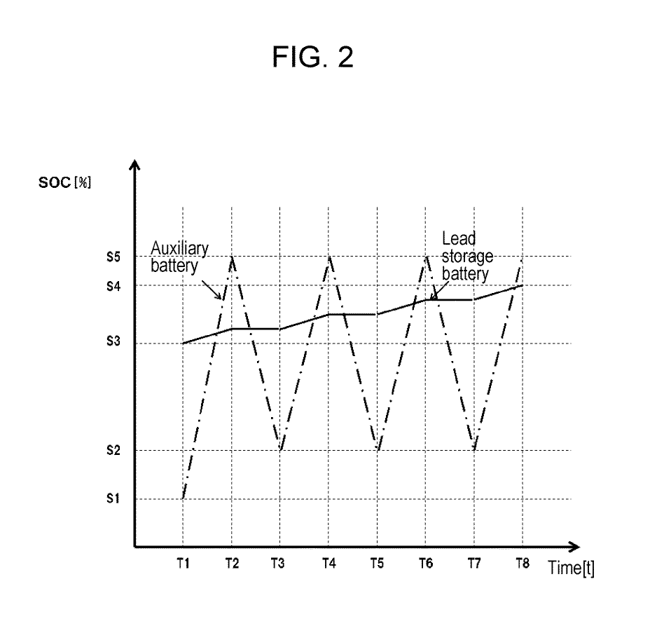

When charge/discharge controller 83 determines that auxiliary battery 72 is in the first charge state, while lead storage battery 71 is in the fourth charge state, charge/discharge controller 83 charges in-vehicle power supply unit 70 with a constant voltage. FIG. 2 is a graph illustrating time transitions in respective charging rates of lead storage battery 71 and auxiliary battery 72 when lead storage battery 71 and auxiliary battery 72 are charged with this constant voltage. Here, S1=5%<S2=30%<S3=80%<S4=95%<S5=100%. With reference to FIG. 2, charging with a constant voltage executed by charge/discharge controller 83 will now specifically be described.

At Timing T1, charging rate SOCp of lead storage battery 71 is assumed to be lower than the fourth threshold value, while charging rate SOCn of auxiliary battery 72 is assumed to be lower than the first threshold value. In this case, at Timing T1, charge/discharge controller 83 determines that lead storage battery 71 is in the first charge state, while auxiliary battery 72 is in the fourth charge state. Then, charge/discharge controller 83 instructs ECU 50 to raise a voltage to be output from ISG 30 to the first voltage. That is, charge/discharge controller 83 executes a process in which the first voltage is applied to in-vehicle power supply unit 70 to charge in-vehicle power supply unit 70 with a constant voltage (also referred to as a first process). Here, for example, 14.5 V can be adopted as the first voltage.

Charging rate SOCp of lead storage battery 71 and charging rate SOCn of auxiliary battery 72 both increase. However, since charge-acceptability of auxiliary battery 72 is superior to charge-acceptability of lead storage battery 71, as illustrated in FIG. 2, a degree of increase in charging rate per unit time for auxiliary battery 72 becomes greater than a degree of increase in charging rate per unit time for lead storage battery 71. Therefore, at Timing T2, charging rate SOCn of auxiliary battery 72 exceeds the second threshold value. Then, charge/discharge controller 83 determines that the charge state of auxiliary battery 72 is transitioned from the first charge state to the second charge state, and instructs ECU 50 to lower an output from ISG 30 to the second voltage. That is, charge/discharge controller 83 executes a process in which the second voltage is applied to in-vehicle power supply unit 70 to cause auxiliary battery 72 to discharge electricity to electrical component load 40 and the like (also referred to as a second process). Here, for the second voltage, a voltage that is lower than the first voltage, and that is within a range in which the voltage is equal to or above open-circuit voltage OCVp (also referred to as a voltage range), which corresponds to the charging rate of lead storage battery 71 at Timing T2, is adopted.

A reason why a voltage output from ISG 30 is lowered to the second voltage is to temporarily lower charging rate SOCn of auxiliary battery 72, because, if charging with the first, constant voltage continues, auxiliary battery 72 will be overcharged. To shorten a time required for charging with a constant voltage, it is preferable that a voltage with which more electricity is discharged from auxiliary battery 72, but less electricity is discharged from lead storage battery 71, i.e. a voltage that is within the voltage range, but as close as possible to open-circuit voltage OCVp of lead storage battery 71 is adopted as the second voltage. As long as a voltage is close to open-circuit voltage OCVp of lead storage battery 71, the second voltage may be greater or lower than open-circuit voltage OCVp. For the second voltage, a voltage obtained by adjusting a voltage output from ISG 30 while referring to first current value Ip so that first current value Ip flowing from lead storage battery 71 becomes zero may be adopted. For the second voltage, a voltage obtained even when first current Ip is not zero, but lower than a predetermined value (for example, 5 A) may be adopted. The predetermined value can be set based on a value (for example, value below 1/20) of first current Ip that is sufficiently lower than a value calculated by multiplying second current value In of auxiliary battery 72 with a rated capacity ratio (rated capacity of lead storage battery 71/rated capacity of auxiliary battery 72). When first current Ip is lower than the predetermined value, charging rate SOCp of lead storage battery 71 is less likely to be lowered, but charging rate SOCn of auxiliary battery 72 is mainly lowered. As a result, a time required for charging with a constant voltage can be shortened.

By applying the second voltage to in-vehicle power supply unit 70, as illustrated in FIG. 2, charging rate SOCn of auxiliary battery 72 lowers, but charging rate SOCp of lead storage battery 71 is almost kept maintained. Therefore, at Timing T3, charging rate SOCp of auxiliary battery 72 is lower than the first threshold value. Then, charge/discharge controller 83 determines that the charge state of auxiliary battery 72 is transitioned from the second charge state to the first charge state, and instructs ECU 50 to raise the voltage output from ISG 30 to the first voltage. That is, charge/discharge controller 83 executes the first process.

Thereafter, when charge/discharge controller 83 determines that the charge state of auxiliary battery 72 is transitioned from the first charge state to a second state, charge/discharge controller 83 executes the second process, and when charge/discharge controller 83 determines that the charge state of auxiliary battery 72 is transitioned from the second charge state to the first charge state, charge/discharge controller 83 executes the first process. That is, each time the charge state of auxiliary battery 72 transitions, charge/discharge controller 83 alternately repeats the first process and the second process.

As a result, at Timing T8, charging rate SOCp of lead storage battery 71 exceeds the third threshold value. Then, charge/discharge controller 83 determines that the charge state of lead storage battery 71 is transitioned to a third state, and instructs ECU 50 to lower the output from ISG 30 to a third voltage. That is, charge/discharge controller 83 finishes charging of in-vehicle power supply unit 70, and lowers the voltage output from ISG 30 so that lead storage battery 71 and auxiliary battery 72 each can discharge electricity. Here, as the third voltage, a voltage in a range from 12 V to 13 V, for example, can be adopted.

Referring now back to FIG. 1, communication part 84 outputs instructions received from charge/discharge controller 83 to ECU 50, as well as outputs battery state information to ECU 50. Storage part 85 is configured by, for example, a nonvolatile, rewritable storage device such as flash ROM to store the I-V table and the first to fourth threshold values.

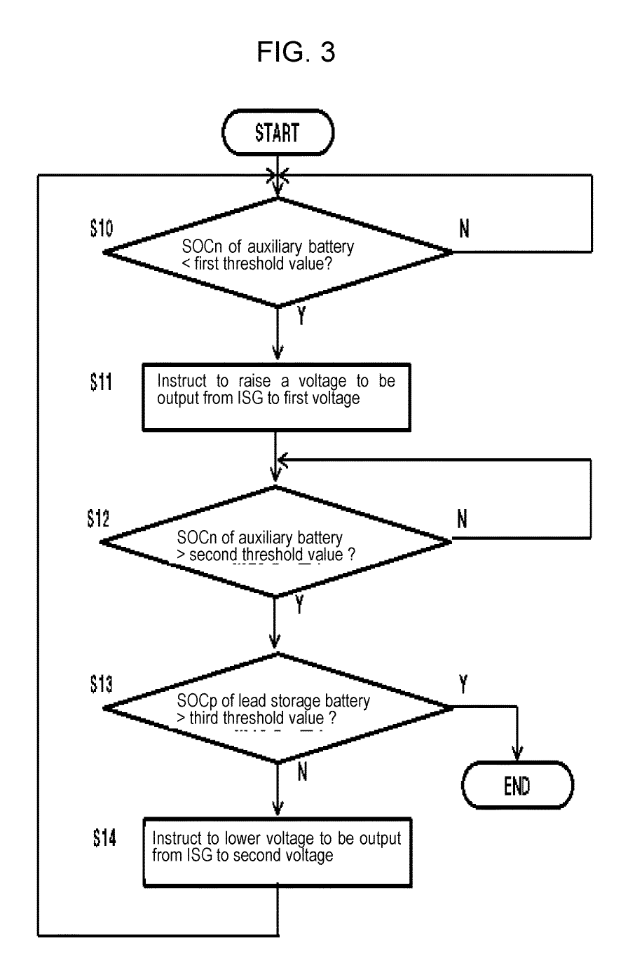

An operation of in-vehicle electricity storage system 60 configured as above will now be described. FIG. 3 is an operation flowchart with regard to a constant voltage charge control performed by the in-vehicle power supply unit. Charge/discharge controller 83 starts charging with a constant voltage of in-vehicle power supply unit 70, and compares charging rate SOCn of auxiliary battery 72 with the first threshold value (S10). When charging rate SOCn of auxiliary battery 72 is lower than the first threshold value (Y in S10), charge/discharge controller 83 instructs ECU 50 to raise a voltage to be output from ISG 30 to the first voltage (S11). Charge/discharge controller 83 compares charging rate SOCn of auxiliary battery 72 with the second threshold value (S12). When charging rate SOCn of auxiliary battery 72 is greater than the second threshold value (Y in S12), charge/discharge controller 83 compares charging rate SOCp of lead storage battery 71 with the third threshold value (S13). When charging rate SOCp of lead storage battery 71 is equal to or below the third threshold value (N in S13), charge/discharge controller 83 instructs ECU 50 to lower the voltage to be output from ISG 30 to the second voltage. On the other hand, when charging rate SOCp of lead storage battery 71 is greater than the third threshold (Y in S13), charge/discharge controller 83 ends charging of in-vehicle power supply unit 70 with a constant voltage.

According to the exemplary embodiment of the present invention, when the charge state of auxiliary battery 72 transitions to the first charge state, charge/discharge controller 83 executes the first process in which the first voltage is applied to in-vehicle power supply unit 70 to charge in-vehicle power supply unit 70 with the constant voltage. When the charge state of auxiliary battery 72 transitions to the second charge state, charge/discharge controller 83 executes the second process in which the second voltage is applied to in-vehicle power supply unit 70, charging of auxiliary battery 72 is stopped, and auxiliary battery 72 is caused to discharge electricity to electrical component load 40 or the like. Charge/discharge controller 83 alternately repeats the first process and the second process until the charge state of lead storage battery 71 transitions to the third charge state. Therefore, since lead storage battery 71 is charged with a higher, constant voltage while preventing overcharge of auxiliary battery 72 connected in parallel, a time required for charging is prevented from being extended. As a result, charging efficiency for lead storage battery 71 is prevented from being lowered. In addition, since no switch needs to be inserted between lead storage battery 71 and auxiliary battery 72, a connection configuration between lead storage battery 71 and auxiliary battery 72 can be simplified and reduced in cost. In addition, an action to open a switch to prevent auxiliary battery 72 from being overcharged becomes unnecessary, operation sounds that occur when the switch is opened, which are uncomfortable to a user, can be eliminated, as well as electrical noises that occur along open and close operations of such a switch can be eliminated. Detector 82 detects charging rate SOCp of lead storage battery 71 as a charge state of lead storage battery 71, and detects charging rate SOCn of auxiliary battery 72 as a charge state of auxiliary battery 72. Charge/discharge controller 83 determines that, when charging rate SOCn of auxiliary battery 72 is lower than the first threshold value, the charge state of auxiliary battery 72 is transitioned to the first charge state, when charging rate SOCn of auxiliary battery 72 exceeds the second threshold value, the charge state of auxiliary battery 72 is transitioned to the second charge state, and determines that, when charging rate SOCp of lead storage battery 71 exceeds the third threshold value, the charge state of lead storage battery 71 is transitioned to the third charge state. Therefore, charging and discharging can be controlled in accordance with the charge states of lead storage battery 71 and auxiliary battery 72 to reliably prevent lead storage battery 71 and auxiliary battery 72 from becoming an overcharge state or an overdischarge state. Detector 82 detects open-circuit voltage OCVp of lead storage battery 71, which corresponds to the charge state of lead storage battery 71. Charge/discharge controller 83 sets the second voltage to be lower than the first voltage, but higher than open-circuit voltage OCVp of lead storage battery 71. At that time, by setting the second voltage close to open-circuit voltage OCVp of lead storage battery 71, a current discharged from lead storage battery 71 can be reduced. By setting the second voltage to be higher than open-circuit voltage OCVp of lead storage battery 71, the current discharged from lead storage battery 71 can be reduced to zero. As a result, in the second process, charging rate SOCp of lead storage battery 71 is almost kept maintained, but the SOCn of auxiliary battery 72 is reduced, thus a time required for charging lead storage battery 71 can be prevented from being extended. Since charge/discharge controller 83 adjusts, via ECU 50, the voltage to be output from ISG 30 so that the first voltage and the second voltage are applied to in-vehicle power supply unit 70, the constant voltage used for charging can easily be adjusted. Since charge/discharge controller 83 adjusts, via ECU 50, an output from ISG 30 so that the second voltage is applied to in-vehicle power supply unit 70, auxiliary battery 72 can easily discharge electricity to electrical component load 40 or the like.

The present invention has been described above based on the exemplary embodiment. It will be appreciated by the person of ordinary skill in the art that this exemplary embodiment is illustrative, that various modified examples may be made in combination of configuration elements and processing processes of the exemplary embodiment, and that such modified examples are also within the scope of the present invention.

The above exemplary embodiment has described an example where the first to fourth threshold values are fixed. In this point, surface temperatures and degradation states of lead storage battery 71 and auxiliary battery 72 may respectively be detected to correct the first to fourth threshold values depending on the detected surface temperatures and the degradation states.

In addition, the above exemplary embodiment has described an example in which vehicle 1 includes power supply controller 80, separately from ECU 50. In this point, ECU 50 may be configured to include function blocks of power supply controller 80 to eliminate power supply controller 80.

The present invention represented with this exemplary embodiment may be identified with items described below.

### [Item 1]

An in-vehicle electricity storage system including: an in-vehicle power supply unit including a lead storage battery, and an auxiliary battery connected in parallel to the lead storage battery; a detector that detects a charge state of the lead storage battery and a charge state of the auxiliary battery; and a charge/discharge controller that executes, when the charge state of the auxiliary battery transitions to a first charge state where charging of the auxiliary battery is to be started, a first process in which a first voltage is applied to the in-vehicle power supply unit to start charging the in-vehicle power supply unit with a constant voltage so as to cause the charge state of the auxiliary battery to transition to a second charge state where the charging of the auxiliary battery is to be stopped, executes, when the charge state of the auxiliary battery transitions to the second charge state, a second process in which the charging with the constant voltage is stopped, and a second voltage that is lower than the first voltage is applied to the in-vehicle power supply unit so as to cause the auxiliary battery to transition to the first charge state, and alternately repeats the first process and the second process until the charge state of the lead storage battery transitions to a third charge state where charging of the lead storage battery is to be stopped.

### [Item 2]

The in-vehicle electricity storage system according to Item 1, wherein the detector detects a charging rate of the lead storage battery as a charge state of the lead storage battery, and detects a charging rate of the auxiliary battery as a charge state of the auxiliary battery, and the charge/discharge controller determines that, when the charging rate of the auxiliary battery is lower than a first threshold value, the charge state of the auxiliary battery is transitioned to the first charge state, when the charging rate of the auxiliary battery exceeds a second threshold value, the charge state of the auxiliary battery is transitioned to the second charge state, and when the charging rate of the lead storage battery exceeds a third threshold value, the charge state of the lead storage battery is transitioned to the third charge state.

### [Item 3]

The in-vehicle electricity storage system according to Item 2, wherein the detector detects an open-circuit voltage of the lead storage battery, the open-circuit voltage of the lead storage battery corresponding to a charge state of the lead storage battery, and the charge/discharge controller sets the second voltage to be lower than the first voltage, and equal to or above the open-circuit voltage of the lead storage battery.

### [Item 4]

The in-vehicle electricity storage system according to Item 3, wherein the charge/discharge controller adjusts a voltage output from a generator connected in parallel to the in-vehicle power supply unit so that the first voltage and the second voltage are applied to the in-vehicle power supply unit.

### [Item 5]

The in-vehicle electricity storage system according to Item 4, wherein the charge/discharge controller adjusts the voltage output from the generator so that the auxiliary battery discharges electricity to an electrical component load connected in parallel to the in-vehicle power supply unit to cause the charge state of the auxiliary battery to transition to the second state.

### INDUSTRIAL APPLICABILITY

An in-vehicle electricity storage system according to the present invention is useful for electric vehicles and the like having an idling stop function and an energy regeneration function.

### REFERENCE MARKS IN THE DRAWINGS

10 engine
20 starter motor
30 ISG
40 electrical component load
50 ECU
51 ISG controller
52 communication part
60 in-vehicle electricity storage system
70 in-vehicle power supply unit
71 lead storage battery
72 auxiliary battery
73 current sensor
74 current sensor
75 voltage sensor
80 power supply controller
81 acquiring part
82 detector
83 charge/discharge controller
84 communication part
85 storage part

1. An in-vehicle electricity storage system comprising:
an in-vehicle power supply unit including a lead storage battery, and an auxiliary battery connected in parallel to the lead storage battery;
a detector that detects a charge state of the lead storage battery and a charge state of the auxiliary battery; and
a charge/discharge controller that
executes, when the charge state of the auxiliary battery transitions to a first charge state where charging of the auxiliary battery is to be started, a first process in which a first voltage is applied to the in-vehicle power supply unit to start charging the in-vehicle power supply unit with a constant voltage so as to cause the charge state of the auxiliary battery to transition to a second charge state where the charging of the auxiliary battery is to be stopped,
executes, when the charge state of the auxiliary battery transitions to the second charge state, a second process in which the charging with the constant voltage is stopped, and a second voltage that is lower than the first voltage is applied to the in-vehicle power supply unit so as to cause the auxiliary battery to transition to the first charge state, and
alternately repeats the first process and the second process until the charge state of the lead storage battery transitions to a third charge state where charging of the lead storage battery is to be stopped.

2. The in-vehicle electricity storage system according to claim 1, wherein
the detector detects a charging rate of the lead storage battery as a charge state of the lead storage battery, and detects a charging rate of the auxiliary battery as a charge state of the auxiliary battery, and
the charge/discharge controller determines that
when the charging rate of the auxiliary battery is lower than a first threshold value, the charge state of the auxiliary battery is transitioned to the first charge state,
when the charging rate of the auxiliary battery exceeds a second threshold value, the charge state of the auxiliary battery is transitioned to the second charge state, and
when the charging rate of the lead storage battery exceeds a third threshold value, the charge state of the lead storage battery is transitioned to the third charge state.

3. The in-vehicle electricity storage system according to claim 2, wherein
the detector detects an open-circuit voltage of the lead storage battery, the open-circuit voltage of the lead storage battery corresponding to a charge state of the lead storage battery, and
the charge/discharge controller sets the second voltage to be lower than the first voltage, and equal to or above the open-circuit voltage of the lead storage battery.

4. The in-vehicle electricity storage system according to claim 3, wherein the charge/discharge controller adjusts a voltage output from a generator connected in parallel to the in-vehicle power supply unit so that the first voltage and the second voltage are applied to the in-vehicle power supply unit.

5. The in-vehicle electricity storage system according to claim 4, wherein the charge/discharge controller adjusts the voltage output from the generator so that the auxiliary battery discharges electricity to an electrical component load connected in parallel to the in-vehicle power supply unit to cause the charge state of the auxiliary battery to transition to the second state.
